(19) United States
(12) Patent Application Publication
(10) Pub. No.: US 2026/0299476 A1
(43) Pub. Date: Oct. 1, 2026

(54) IMAGE FORMING APPARATUS

(71) Applicant: CANON KABUSHIKI KAISHA, Tokyo (JP)

(72) Inventors: NAOKA OMURA, Chiba (JP); TOMOHIRO HASEGAWA, Chiba (JP)

(21) Appl. No.: 19/576,508

(22) Filed: Mar. 24, 2026

(30) Foreign Application Priority Data
Mar. 25, 2025 (JP) 2025-050627

(51) Int. Cl. G03G 15/00; G06K 15/00; G06K 15/02

(52) U.S. Cl. CPC G03G 15/5016; G03G 15/6579; G06K 15/005; G06K 15/1809; G06K 15/4075; G06K 15/408; G03G 2215/00582

(57) ABSTRACT

An image forming apparatus includes an image forming unit configured to form an image on an image bearing member using toner, a transfer member configured to transfer the image on the image bearing member onto a sheet while conveying the sheet in a conveyance direction, and a controller configured to perform a print job to form a first page image on a downstream side of a center position of the sheet in the conveyance direction and form a second page image on an upstream side of the center position of the sheet in the conveyance direction, and control, in the print job, image formation by the image forming unit based on a toner amount of the first page image such that a downstream edge of the second page image in the conveyance direction is positioned at the center position of the sheet.

### BACKGROUND

### Field of the Technology

The present disclosure relates to an image forming apparatus capable of suppressing positional deviation of an image.

### Description of the Related Art

In an image forming apparatus, it is desirable to control positional deviation which is a phenomenon in which an image position is displaced relative to a sheet. The positional deviation may occur due to various factors, such as a printing ratio.

The printing ratio refers to the total area of printed characters or images relative to the total area of a paper sheet. Higher printing ratio results in higher toner usage per sheet. Compared to forming images with a low printing ratio, forming images with a high printing ratio changes a conveyance speed of a sheet. Resultingly, the image formed on each sheet may shrink, causing the image position to deviate relative to the sheet.

Regarding positional deviation caused by the printing ratio of an image, the image forming apparatus disclosed in Japanese Patent Application Laid-open No. 2019-74586 corrects an amount of positional deviation by performing a magnification correction relative to an image size according to the printing ratio of the image to be formed.

The method described in Japanese Patent Application Laid-open No. 2019-74586 is effective in a case where the printing ration is uniform across the formed image. However, in some cases, the formed image includes both text and graphics, and the printing ratio may vary across different regions within the formed image. Thus, expected effects are not always achieved. For example, in printed product such as saddle-stitched books or folded pamphlets where the sheet is folded in half, the left and right sides of the fold become separate pages. Thus, image data having different contents may be laid out to the respective pages. When image data having different printing ratio is respectively laid out to a left side and a right side of the fold, the conveyance speed changes within the sheet surface. Therefore, even if the image magnification is corrected according to the overall printing ratio of the sheet, the positional deviation cannot be sufficiently corrected.

Furthermore, if the image that should be laid out to the left side of the fold or the image that should be laid out to the right side of the fold extends beyond the fold, it significantly degrades the quality of the printed product. Therefore, for printed products with folds, it is necessary to prioritize correcting the positional deviation of the image at the center over the positional deviation of the image at a leading or a trailing edge of the sheet in the sheet conveyance direction. However, simply correcting the magnification based on the overall image printing ratio of the sheet is insufficient for correcting the positional deviation of the image at the center

### SUMMARY

An image forming apparatus according to one embodiment of the present disclosure includes an image forming unit configured to form an image on an image bearing member using toner, a transfer member configured to transfer the image on the image bearing member onto a sheet while conveying the sheet in a conveyance direction, and a controller configured to perform a print job to form a first page image on a downstream side of a center position of the sheet in the conveyance direction and form a second page image on an upstream side of the center position of the sheet in the conveyance direction, and control, in the print job, image formation by the image forming unit based on a toner amount of the first page image such that a downstream edge of the second page image in the conveyance direction is positioned at the center position of the sheet.

An image forming apparatus according to another embodiment of the present disclosure includes an image forming unit configured to form an image on an image bearing member using toner, a transfer member configured to transfer the image on the image bearing member onto a sheet while conveying the sheet in a conveyance direction, and a controller configured to perform a print job to form a first page image on a downstream side of a center position of the sheet in the conveyance direction and form a second page image on an upstream side of the center position of the sheet in the conveyance direction, and control, in the print job, image formation by the image forming unit based on a toner amount of the first page image such that an upstream edge of the first page image in the conveyance direction is positioned at the center position of the sheet.

Features of the present disclosure will become apparent from the following description of embodiments with reference to the attached drawings. The following description of embodiments is described by way of example.

### BRIEF DESCRIPTION OF THE DRAWINGS

FIG. 1 is an explanatory diagram of a print system.

FIG. 2 is a configuration diagram of an image forming apparatus.

FIG. 3 is an explanatory diagram of a count region.

FIG. 4A is a graph illustrating a relationship between a printing ratio and an amount of positional deviation.

FIG. 4B is a graph illustrating a relationship between a sheet length and a positional deviation amount.

FIG. 5 is an explanatory diagram illustrating a correction for image data.

FIG. 6 is a flowchart illustrating a printing process.

FIG. 7 is a flow chart illustrating a process of aligning an image output position to a center of a sheet.

FIG. 8 is an explanatory diagram illustrating correction for image data using a partial magnification correction.

FIG. 9 is a flow chart for representing correction for image data using the partial magnification correction.

### DESCRIPTION OF THE EMBODIMENTS

A first embodiment and a second embodiment of the present disclosure will be described with reference to the accompanying drawings.

### First Embodiment

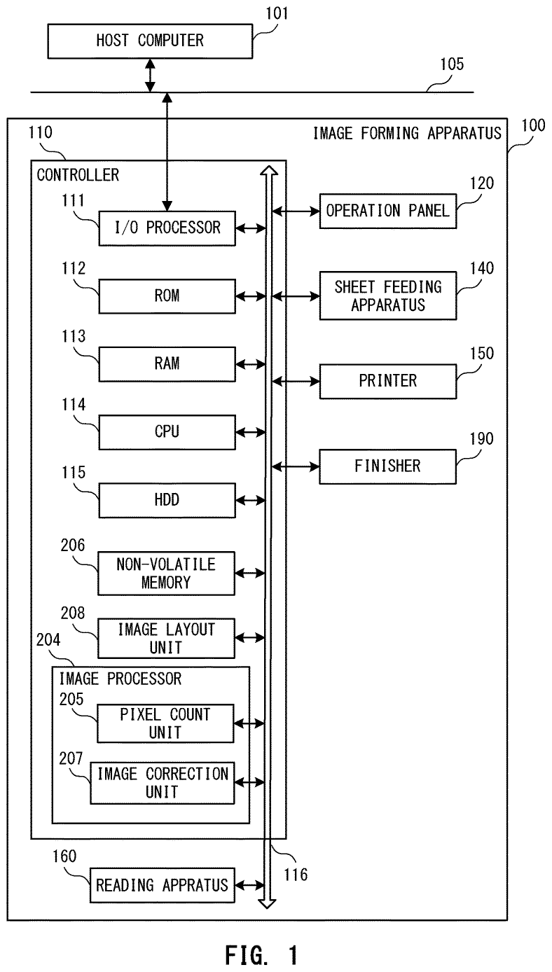

FIG. 1 is an explanatory diagram of a printing system including an image forming apparatus according to the first embodiment. The printing system includes an image forming apparatus 100 and a host computer 101. The image forming apparatus 100 and the host computer 101 are connected to each other so as to enable communication therebetween through a network 105. The network 105 is, for example, a communication line such as a local area network (LAN) or a wide area network (WAN). A plurality of image forming apparatuses 100 may be connected to the network 105, and a plurality of host computers 101 may also be connected to the network 105.

The host computer 101 is, for example, a server, and transmits a print job to the image forming apparatus 100 through the network 105. The print job includes various kinds of information required for printing, such as image data representing an image (output image) to be formed, a type of paper sheet or a sheet used for printing, the number of sheets to be printed, and designation of duplex or simplex printing. Hereinafter, “paper sheet” and “sheet” may be referred to simply as “sheet.” Additionally, a user can configure the post-processing performed by a finisher 190 for print jobs.

The image forming apparatus 100 forms an image on a sheet based on a print job. For this purpose, the image forming apparatus 100 includes a controller 110, an operation panel 120 which serves as an operation unit, a sheet feeding apparatus 140, a printer 150, and a reading apparatus 160. The controller 110, the operation panel 120, the sheet feeding apparatus 140, the printer 150, the reading apparatus 160, and the finisher 190 are connected to each other through a system bus 116 so as to enable communication therebetween.

The operation panel 120 is a user interface and is equipped with operation buttons, a numeric keypad, and a liquid crystal display (LCD). An operator can input a print job, a command, a print setting, and the like to the image forming apparatus 100 through the operation panel 120. The image forming apparatus 100 performs an image forming process based on a print job acquired from one of the host computer 101 and the operation panel 120. The operation panel 120 displays a state of the image forming apparatus 100 and a setting screen on the LCD.

The sheet feeding apparatus 140 includes a plurality of sheet feeding stages that receive sheets. The sheet feeding apparatus 140 feeds one sheet at a time in order from the uppermost sheet of a bundle of a plurality of sheets (a sheet bundle) stacked on each sheet feeding stage. The sheet feeding apparatus 140 conveys, to the printer 150, the sheet fed from each sheet feeding stage. The printer 150 forms an image on the sheet fed from the sheet feeding apparatus 140 based on the image data included in the print job to generate a printed sheet. The reading apparatus 160 reads the printed sheet generated by the printer 150 to transmit a reading result thereof to the controller 110.

The controller 110 is a control unit to control an operation of each part of the image forming apparatus 100. The controller 110 includes a read only memory (ROM) 112, a random access memory (RAM) 113, and a central processing unit (CPU) 114. The controller 110 includes an I/O control unit 111 and a hard disk drive (HDD) 115 as a storage. As the storage, it is also possible to use large-capacity storage devices such as a solid state drive (SSD) instead of the HDD. Each part within the controller 110 is connected to the system bus 116.

The I/O control unit 111 is a communication interface which communicates with an external apparatus such as the host computer 101 via the network 105. The CPU 114 comprehensively controls the operation of the image forming apparatus 100 by performing a control program stored in the ROM 112 or the HDD 115, using RAM 113 as a working area. The HDD 115 stores various data such as the control program and image data used for the image forming process (e.g., printing process).

Image data input via the network 105 is stored in a non-volatile memory 206. An image layout unit 208 combines and lay outs multiple input image data stored in non-volatile memory 206 to form a single image data according to settings configured by the operator using the operation panel 120, and stores it in the non-volatile memory 206. For example, when two pages of A4 input images are laid out on a single page of A3 print page, the two pages of A4 input image data are laid out sequentially in a sub-scanning direction (conveyance direction).

The input image data stored in the non-volatile memory 206 is input to an image processing unit 204. The image processing unit 204 includes a pixel count unit 205 and an image correction unit 207. The pixel count unit 205 accumulates density values of the respective pixels constituting the image data for each color component of Y, M, C, and K.

In the present embodiment, the density value of each pixel includes 8 bits (0-255) tones. For example, as to the component of Y of the image, if the density value of the first pixel is 100 and the density value of the second pixel is 50, the accumulated value of the first and second pixels is 150. Such accumulation of pixel values is performed for all pixels within a predetermined region and for all color components.

The pixel count value calculated by the pixel count unit 205 is stored in a register (not illustrated) within the pixel count unit 205. Upon completing the count of pixels in a count region, the pixel count unit 205 sends an interrupt signal to the CPU 114. In the controller 110, the interrupt signal serves as a trigger, and based on the control program, the CPU 114 reads this register to acquire the pixel count value at that point in time.

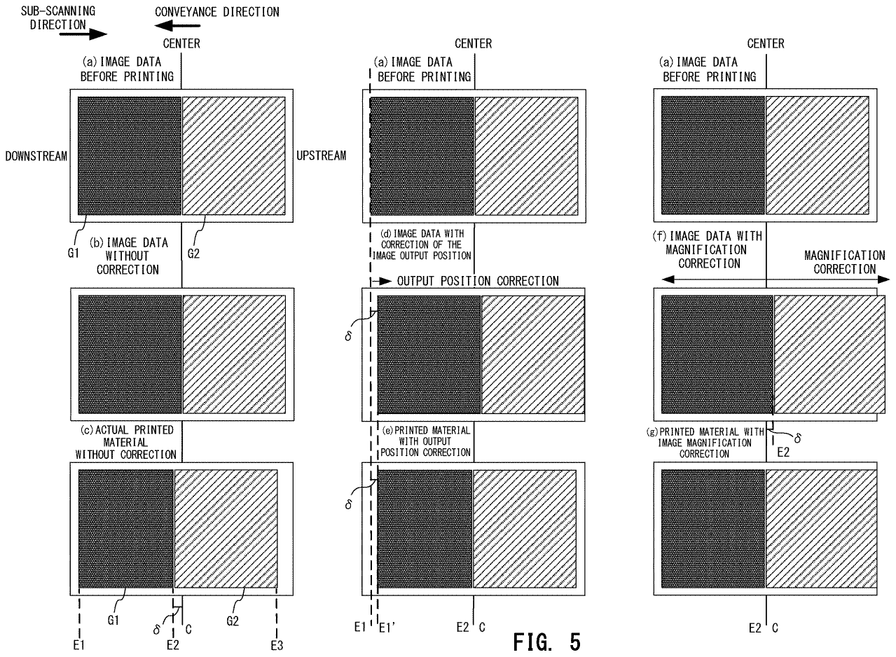

The image correction unit 207 corrects a writing position or a magnification of the image to be printed onto the sheet. The CPU 114 calculates a correction amount and sets the image writing position or the magnification of the image in the image correction unit 207. The specific method for calculating the correction amount will be described later with reference to FIG. 5.

### Configuration of Image Forming Apparatus

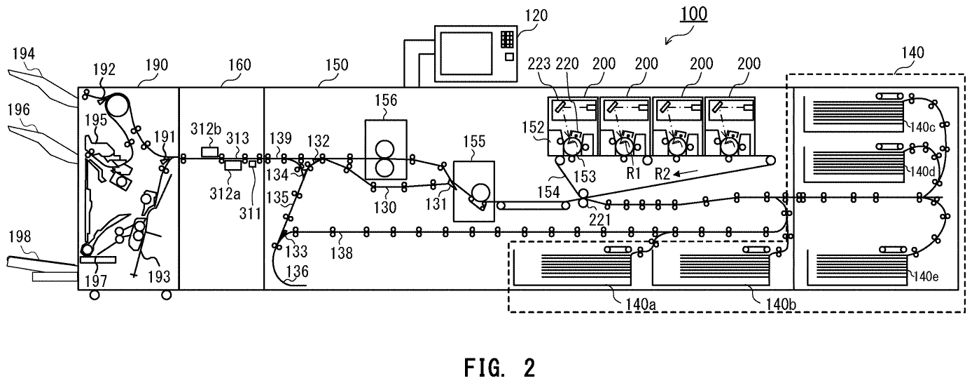

FIG. 2 is a configuration diagram of the image forming apparatus 100. The image forming apparatus 100 includes the finisher 190 in addition to the sheet feeding apparatus 140, the printer 150, and the reading apparatus 160, which have been described with reference to FIG. 1. The finisher 190 is a post-processing apparatus that performs predetermined post-processing on the printed sheet generated by the printer 150. The finisher 190 performs, for example, a saddle stitching process, staple processes for a plurality of the printed sheet, a sort process of the printed sheet.

The printer 150 includes a plurality of image forming units 200 (in the first embodiment, four image forming units) which form images of different colors. Yellow, magenta, cyan, and black images are formed by the four image forming units 200. Each of the image forming units 200 serves as a printing unit, and has substantially the same configuration.

The image forming unit 200 includes a photosensitive drum 153, which serves as an image bearing member for a toner image, a charging unit 220, an exposing device 223, and a developing device 152. The photosensitive drum 153 is driven to rotate by a drive force of a motor (not illustrated) in a direction indicated by an arrow R1. The charging unit 220 uniformly charges the photosensitive drum 153 being rotated. The exposing device 223 exposes, based on the image data, the uniformly charged photosensitive drum 153. Thus, an electrostatic latent image is formed on the photosensitive drum 153 according to the image data. The developing device 152 develops the electrostatic latent image using a developer (toner) of the corresponding color. The electrostatic latent image on the surface of the photosensitive drum 153 is visualized by the developing to form an image of the corresponding color on the photosensitive drum 153.

The printer 150 includes an intermediate transfer belt 154, which serves as a transfer unit, onto which each image formed by a plurality of the image forming units 200 is transferred. The sheet feeding apparatus 140 includes a plurality of sheet feed stages 140a, 140b, 140c, 140d, 140e, each accommodating sheets. The sheet feeding apparatus 140 supplies sheets to the printer 150 from the sheet feed stage that contains sheets of the type (size, paper quality, etc.) specified by the print job. The sheets supplied to the printer 150 is transferred to a transfer section. The intermediate transfer belt 154 is driven to rotate in the direction of arrow R2. The yellow, magenta, cyan, and black images formed by the plurality of the image forming units 200 are transferred onto the intermediate transfer belt 154 so as to be superimposed on each other at timings corresponding to the rotational speed of the intermediate transfer belt 154. Thus, a full-color image is formed on the intermediate transfer belt 154. The image on the intermediate transfer belt 154 is conveyed due to the rotation of the intermediate transfer belt 154 to the transfer section formed between the intermediate transfer belt 154 and the transfer roller 221.

The image formed on the intermediate transfer belt 154 is transferred onto the sheet conveyed from the sheet feeding apparatus 140 at the secondary transfer nip section formed by the intermediate transfer belt 154 and the transfer roller 221. The printer 150 fixes the image onto the sheet by heating and applying pressure to the image transferred onto the sheet. The printer 150 includes a first fixing device 155 and a second fixing device 156.

The first fixing device 155 includes a fixing roller with an internal heater and a pressure belt for pressing the sheet against the fixing roller. The fixing roller and the pressure belt are driven by motors (not illustrated) to nip and convey the sheet.

The second fixing device 156 is arranged downstream of the first fixing device 155 in a conveyance direction of the sheet. The second fixing device 156 is used for increasing a gloss of the image on the sheet that has passed through the first fixing device 155 and for ensuring fixability. The second fixing device 156 includes a fixing roller with an internal heater and a pressure roller with an internal heater. Depending on a type of the sheet, the second fixing device 156 may not be used. In this case, the sheet is conveyed from the fixing device 155 to a conveyance path 130 without being conveyed to the second fixing device 156. To that end, a flapper 131 that guides the sheet to one of the conveyance path 130 and the second fixing device 156 is provided downstream of the first fixing device 155.

A flapper 132 that guides the sheet to one of a conveyance path 135 and a discharge path 139 is provided downstream of the second fixing device 156 and the conveyance path 130. For example, the flapper 132 guides the sheet on which an image has been formed on a first surface in a double-sided printing mode to the conveyance path 135. For example, the flapper 132 guides the sheet on which an image has been formed on a first surface in a face-up discharging mode to the discharge path 139. For example, the flapper 132 guides the sheet on which an image has been formed on a first surface in a face-down discharging mode to the conveyance path 135. Further, after an image has been formed on a first surface of the sheet, the flapper 132 guides the sheet to the conveyance path 135 in order to print an image on a second surface of the sheet.

The sheet conveyed to the conveyance path 135 is conveyed to a reversing section 136. After a conveyance operation of the sheet conveyed to the reversing section 136 has been temporarily stopped, the sheet is reversed in the conveyance direction. A flapper 133 and a flapper 134 are provided in the conveyance path 135. The sheet reversed in the conveyance direction is guided to any one of a conveyance path 138 and the conveyance path 135 by the flapper 133. For example, the flapper 133 guides the sheet that has been switched back in the double-sided printing mode to the conveyance path 138. For example, the flapper 133 guides the sheet that has been switched back in the face-down discharging mode to the conveyance path 135. The sheet guided to the conveyance path 135 by the flapper 133 is guided to the discharge path 139 by the flapper 134. The flapper 133 guides the sheet that has been switched back to print an image on a second surface of the sheet to the conveyance path 138.

The sheet conveyed to the conveyance path 138 by the flapper 133 is conveyed toward the nip portion (transfer section) between the intermediate transfer belt 154 and the transfer roller 221. As a result, the front and back sides of the sheet when passing through the transfer section are reversed. That is, the surface of the sheet where the image is transferred is reversed. The finisher 190 is connected on downstream of the printer 150 in the conveyance direction of the sheet, and the printed sheet is conveyed to the finisher 190.

The reading apparatus 160 includes a document detection sensor 311 and two line sensor units 312a and 312b, arranged sequentially from the upstream side in the conveyance direction of the sheet along a conveyance path 313. Sheets conveyed from the printer 150 to the reading apparatus 160 are conveyed along the conveyance path 313. The reading apparatus 160 reads the sheet on which an image has been formed using the line sensor units 312a and 312b. After the image has been read, the sheet is conveyed along the conveyance path 313 to the finisher 190.

The document detection sensor 311 is, for example, an optical sensor having an emitting element and a receiving element. The document detection sensor 311 detects a leading edge (sheet leading edge) of the test sheet during its conveyance along the conveyance path 313 in the conveyance direction. The controller 110 initiates a reading operation of a correction chart by the reading apparatus 160 (line sensor units 312a, 312b) based on the timing of the sheet leading edge detection by the document detection sensor 311.

The line sensor units 312a and 312b read the image formed on the test sheet. The line sensor units 312a and 312b are disposed on opposite sides of the conveyance path 313 to read images from both sides of the sheet. The line sensor unit 312a reads an image formed on a front surface (first surface) of the sheet. The line sensor unit 312b reads an image formed on a back surface (second surface) of the sheet. In the first embodiment, the line sensor unit 312b is disposed downstream relative to the line sensor unit 312a in the conveyance direction of the sheet.

The finisher 190 performs predetermined post processing, set by the user via the print job, on the sheet conveyed along the conveyance path 313. The finisher 190 can perform post processing such as a stapling process (single point or double point binding), a punching process (two hole or three hole), and a saddle stitching process. The finisher 190 includes three discharge sections, i.e., two discharge trays 194 and 196, and a saddle stitching tray 198. The finisher 190 includes flappers 191, 192, a saddle stitching unit 193, a needle stitching unit 195, and a conveyance unit 197.

In a case where no post processing such as the stapling process is performed, the sheet is discharged to the discharge tray 194 by the flappers 191 and 192. In a case where the stapling process is performed, the sheet is conveyed to the needle stitching unit 195 by the flappers 191 and 192. The needle stitching unit 195 performs the stapling process on the conveyed sheet. The sheet to which the staple process has been performed is discharged to the discharge tray 196.

If saddle stitching process is set as the post-processing, the sheet is conveyed to the saddle stitching unit 193. The saddle stitching unit 193 performs the saddle stitching process by stapling the center of the sheet and then folding the sheet in half. Upon completion of the saddle stitching process, the bound sheet bundle (saddle stitched bundle) is discharged to the saddle stitching tray 198 via the conveyance unit 197. The saddle stitching tray 198 is configured as a belt conveyer. The saddle stitched bundle stacked onto the saddle stitching tray 198 is conveyed by a belt conveyer to the left side of FIG. 2.

### Pixel Counting Method for Divided Region

A method is described for setting multiple regions in the image data and performing pixel counting for each set region using the pixel count unit 205. As described later, performing pixel counting for each region enables the determination of the image shrinkage amount and an amount of positional deviation for each region. The region for which pixel counting is performed (hereinafter referred to as “count region”) can be set arbitrarily. However, in one example, the count region is set to one page size. In a case where the page size is A4 size (height 297 mm*width 210 mm) and the resolution is set to 1200 dpi, the height (297 mm) corresponds to 14,032 pixels and the horizontal width (210 mm) corresponds to 9,921 pixels. Therefore, the pixel count unit 205 performs accumulation for 14032*9921=139,211,472 pixels per page for each color component.

As another example of the count region, the image of one page is divided along a direction (hereinafter referred to as “main scanning direction”) perpendicular to the conveyance direction, and each divided region is defined as the count region. Alternatively, the image of one page may be divided along the conveyance direction, and each divided region is defined as the count region. In these cases, each divided region is defined as the count region, further, multiple regions where pixel counting is performed are set in a single page.

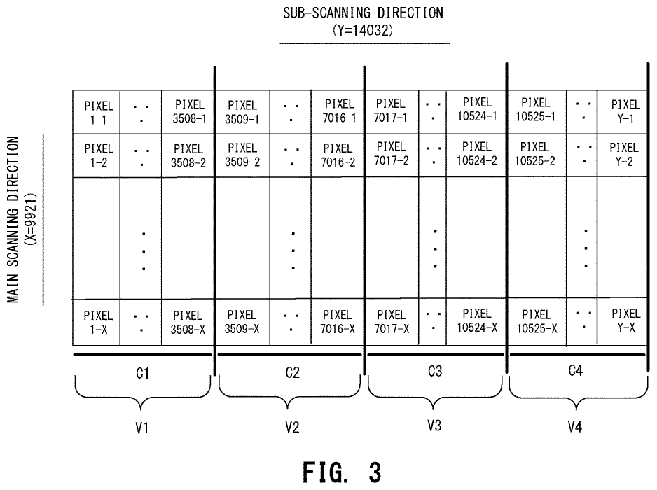

FIG. 3 is an explanatory diagram of the count region. In the illustrated example, the count regions are formed by dividing the image into n equal parts (n=4 in this example) in the sub-scanning direction. Further, the image of one page has X pixels in the main scanning direction and Y pixels in the sub-scanning direction (in this example, X=9921, Y=14032). Each count region is illustrated sequentially from the left in the sub-scanning direction as count regions C1 through C4. Each count region has 3508 pixels in the sub-scanning direction, and their lengths are each a common value L (in this example, 297/4=74.25 mm). Therefore, in the sub-scanning direction, the trailing edge of the count region C1 includes pixels 3508-1, 3508-2, . . . , and 3508-X (i.e., 9921), and the trailing edge of the count region C2 includes pixels 7016-1, 7016-2, . . . , 7016-X. Similarly, in the sub-scanning direction, the trailing edge of the count region C3 includes pixels 10524-1, 10524-2, . . . , 10524-X, and the trailing edge of the count region C4 includes pixels Y (i.e., 14032)-1, Y-2, . . . , Y-X.

In a case where input image data is input into the image processing unit 204, the pixel count unit 205 accumulates, in the main scanning direction, the density value of each pixel from a pixel 1-1 to a pixel 1-X for every color component. The calculated pixel count value is stored in an internal register of the pixel count unit 205. Next, the pixel count unit 205 accumulates, in the main scanning direction, the density value of each pixel from a pixel 2-1 to a pixel 2-X for each color component, and the accumulated value is added to the pixel count value stored in the register. Then, similar operation is continued and the accumulated value of the density value of each pixel from pixel 3508-1 to pixel 3508-X, corresponding to the position at the right edge of the count region C1 in FIG. 3, is added to the count value stored in the register. As a result, the count value stored in the register becomes the accumulated value of the density value for each color component of each pixel from pixel 1-1 to pixel 3508-X within the count region C1. In FIG. 3, the accumulated value is illustrated as a pixel count value V1. After the pixel count value V1 completes accumulation, the CPU 114 reads the register to acquire the pixel count value V1. Using the same method, the CPU 114 acquires pixel count values V2 through V4 for each of the count regions C2 through C4.

In a case where toner is interposed between the intermediate transfer belt 154 and the sheet in the secondary transfer nip section, the intermediate transfer belt 154 applies a conveying force to the sheet via the toner. A toner image carried on the photosensitive drum 153 is transferred onto the sheet while the sheet is being conveyed. As a result, the conveyance speed of the sheet changes depending on the amount of toner on the intermediate transfer belt 154, causing the image to shrink. Consequently, a positional deviation occurs between the image in the image data and the image printed on the sheet. The amount of toner present on the intermediate transfer belt 154 is hereinafter referred to as a “toner amount.” To determine the amount of the positional deviation between the image in the image data and the image printed on the sheet, in the first embodiment, a pixel count value correlated with the toner amount is used. By determining an amount correlated with the toner amount used to form the image in each count region, the toner amount in each count region is determined. The toner amount does not necessarily need to be determined directly, it is possible to determine the amount of positional deviation using an amount correlated with the toner amount. In the first and second embodiments, as described above, at least one of a count value, a density value, and a printing ratio, which are correlated with the toner amount, is used.

The pixel count unit 205 serves as a determination unit that determines the toner amount used to form the image for multiple regions set in the image data. In the following example, the printing ratio for a region is acquired from the pixel count value, and the amount of positional deviation of the image is calculated from the printing ratio. In the specification, the printing ratio is also related to density value of a pixel such that the higher the pixel density value, the higher the printing ratio. In the first and second embodiments, the printing ratio is acquired as (Pixel Count Value/Number of Pixels on a Sheet)*100 (%). For example, for an A4 sheet (139,211,472 pixels) where the pixel count value for Y is 69,605,736 pixels, the printing ratio for toner Y is (69,605,736/139,211,472)*100=50 (%). Similarly, the printing ratio for toner M, toner C, and toner K can be acquired respectively. The average of these printing ratios acquired for each toner color is the printing ratio for all toner colors. Hereinafter, the printing ratio for all toner colors acquired in this manner will be referred to simply as “toner printing ratio”. Furthermore, the printing ratio for each count region C1 through C4 is calculated as (Pixel Count Value/Number of Pixels within the Count Region)*100 (%).

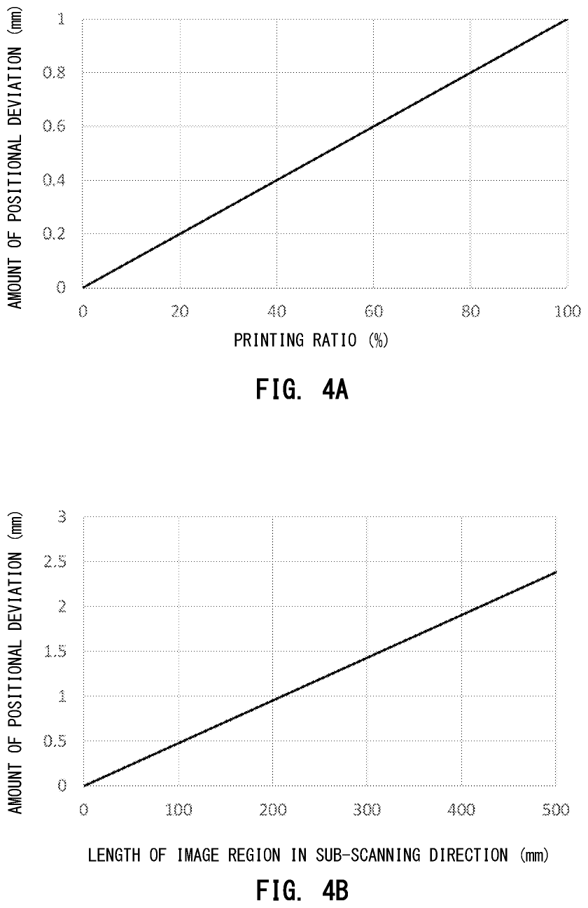

The amount of a positional deviation of an image on the sheet due to the printing ratio of the toner is explained using FIGS. 4A and 4B. FIG. 4A is a graph illustrating a relationship between the printing ratio and an amount of positional deviation of an image for image data (length of an image region in the sub-scanning direction=210 mm) to be printed on an A4 sheet. As illustrated, when printing an image with 100% printing ratio, the image deviates by 1 mm in the sub-scanning direction at the trailing edge of the printed product (i.e., the sheet with the printed image). Here, a position deviated toward the leading edge of the sheet by a predetermined margin amount from the trailing edge of the sheet is defined as an ideal position of the trailing edge of the image. A positional deviation of the image is a difference between the ideal position of the trailing edge of the image and an actual position of the trailing edge of the image. Furthermore, this graph is a straight line passing through the origin, indicating that the amount of the positional deviation and the printing ratio are in a nearly directly proportional relationship.

FIG. 4B is a graph illustrating a relationship between a length of the image region in the sub-scanning direction at 100% printing ratio and an amount of positional deviation of the trailing edge of the image formed on the sheet. As shown in the figure, this graph is a straight line passing through the origin, the amount of positional deviation is approximately ( 1/210) times the length of the image area in the sub-scanning direction, and is in a nearly directly proportional relationship.

In the first embodiment, assuming that the positional deviation of the image is proportional to both the printing ratio and the length of the image region in the sub-scanning direction, the positional deviation at the trailing edge of the image formed on the sheet (trailing edge of the image) is acquired as illustrated in the following Equation 1.

$$Positional deviation ( mm ) = \{ Length of image data in sub - scanning direction ( mm ) \} * \{ Printing ratio * ( 1 / 210 ) \} \qquad Equation 1$$

As to Equation 1, the length of the sheet in the sub-scanning direction in the output image is 210 mm for A4 size, 297 mm for A4R size, and 420 mm for A3 size. As described above, in a case where the printing ratio is 100%, the positional deviation amount corresponding to the A3 image data is 2 mm, and the positional deviation amount corresponding to the A4 image data is 1 mm.

In a case where the image data is divided into multiple regions (count regions C1 through C4), the count value is determined for each region. Thus, the image shrinkage amount can be determined for each of the count regions C1 through C4. Further, for each edge of the count regions C1 through C4, it is possible to determine the amount of positional deviation between the edge position in the image data and the edge position on the sheet. In a case where the image shrinkage amount for the count region C1 is 0.6 mm, and the shrinkage amount for the count region C2 is 0.4 mm, the positional deviation of the trailing edge of the count region C1 (and the front edge of the count region C2) from the image leading edge is 0.6 mm. On the other hand, the positional deviation of the trailing edge of the count region C2 (and the front edge of the count region C3) from the image leading edge is the sum of the shrinkage amounts for count regions C1 and C2 (0.6+0.4=1.0 mm). Similarly, by accumulating the shrinkage amounts for each count region, the positional deviation of the front and trailing edges of the count regions C3 and C4 from the image leading edge can also be determined.

In this embodiment, coefficients for the calculation formula in FIGS. 4A and 4B are determined from experimentally acquired values. However, the coefficients for the calculation formula may also be determined by printing test charts for different printing ratios and detecting the image positional deviation amount using the reading apparatus 160. Furthermore, the calculation formula is not limited to the form of Equation 1. Any approximation formula, such as linear approximation, quadratic approximation, polynomial approximation, or power approximation, can be used as long as it allows the positional deviation to be calculated.

### Method for Centering the Image

Next, printed products intended for printing where the sheet is to be folded in half (divided into two equal parts), or into three, four, or n equal parts, such as saddle-stitched books or folded pamphlets are described. Such printed products have folds. For example, when folding the sheet in half, the position corresponding to the center of the image data corresponds to the position of the fold on the printed product. For convenience, in the present disclosure, in printing that is intended to be folded, the printed product may be described as having a fold even before the fold is actually formed. Particularly, in a case where the image layout unit 208 lays out n images to a single image data for printing, it is important that the boundaries between images in the image data correspond to the fold lines on the printed product.

On the other hand, as to the image after performing lay out processing by the image layout unit 208, the printing ratio may differ for each laid out image. For example, in a case where two images are laid out, the printing ratio of the image laid out downstream of the sheet in the conveyance direction may differ from that of the image laid out upstream of the sheet. In this case, differences in the image shrinkage cause positional deviation between the center position of the image data and the center position (fold) of the sheet, i.e., the printed product, where the image is formed. The following description describes an example where the center position of the image data is aligned with the center position of the sheet even in such cases.

FIG. 5 illustrates an explanatory diagram of correction for image data where the printing ratio of the image on the downstream side in the conveyance direction of the sheet is high, and the printing ratio of the image on the upstream side in the conveyance direction is low. In FIG. 5, the conveyance direction is leftward, and the right side of the sheet is upstream, while the left side is downstream. In FIG. 5, the sheet is A3 size, and the positional deviation of a downstream edge of the image in the downstream half region of the sheet (hereinafter referred to as “image G1”) in the conveyance direction is 1 mm. Further, the center position of the sheet (indicated as “CENTER” in the figure) corresponds to a fold position in saddle stitching. The shrinkage amount of the image in the upstream half region in the conveyance direction (hereinafter referred to as “image G2”) is shorter compared to the shrinkage amount of the image G1. In a case where the images G1 and G2 are laid out as pages to be printed, the image G1 corresponds to the first page formed downstream of the sheet's center position, and the image G2 corresponds to the second page formed upstream of the sheet's center position. Furthermore, to avoid complicating the drawings, the symbols G1 and G2 representing images G1 and G2, respectively, are illustrated only in (a) and (c) in FIG. 5. Additionally, the printing ratio for each of the images G1 and G2 is acquired from the sum of the density values for each color component of each pixel contained within the image, similar to the count regions C1 through C4 in FIG. 3.

Hereinafter, in the images G1 and G2, the downstream edge in the conveyance direction illustrated in the figure is referred to as “leading edge”, and the upstream edge in the conveyance direction is referred to as “trailing edge”. In FIG. 5, (a) illustrates the image data before printing, and (b) illustrates the image data when no correction based on the print density is applied by the image correction unit 207. In this case, since no correction is applied to the image data, in FIG. 5, (a) and (b) are identical. In FIG. 5, (c) illustrates the actual printed product in a case where the image data is printed without correction. As illustrated, since the image G1 has a high printing ratio, it is shrunk on the printed product, with a reduction amount of 1 mm. Consequently, the trailing edge of the image G1 (and the front edge of the image G2) is printed 1 mm to the left of the image center position. The image G2 is also shrunk according to its printing ratio. However, in the illustrated example, as described later, the printing ratio of the image G2 is lower than that of the image G1, resultingly, the substantial positional deviation is 0 mm.

For simplicity, in FIG. 5, (c) illustrates the leading edge of the image G1 as E1, the trailing edge of the image G1 as E2, and the trailing edge of the image G2 as E3. Furthermore, the leading edge of the image G2 coincides with the trailing edge of the image G1, and both are illustrated as E2.

In FIG. 5, as to (c), the positional deviation amount of the image G1 is illustrated as the distance “δ” between the trailing edge E2 of the image G1 and the center of the sheet (indicated as “C” in the figure). As described above, in (c) through (g) of FIG. 5, δ=1 mm. As a result of this positional deviation, the center of the sheet is located within the image G2. Thus, in a case where the sheet is folded in half, the fold is positioned within the image G2, leading to a decrease in print quality. As examples to resolve this positional deviation in the image, two methods, i.e., a method of changing the image output position relative to the leading edge of the image G1, and a method of changing the image magnification in the conveyance direction will be described.

In FIG. 5, (d) illustrates image data when correcting the image output position by calculating the amount of the positional deviation of the image based on the printing ratio to correct the image data output position. The image correction unit 207 corrects the image data by adjusting the output position so that the amount of the positional deviation δ is suppressed or compensated. As a result, the image data output timing is delayed by an amount such that the position of the leading edge E1′ of the image G1 on the printed product is deviated by δ (equal to 1 mm) relative to the leading edge E1 of the image G1.

In FIG. 5, (e) illustrates the printed product with the output position corrected, where the trailing edge of the image G1 is positioned at the center of the sheet. In the illustrated example, since the positional deviation amount δ of the trailing edge of the image G1 in the conveyance direction of the A3 sheet is 1 mm, the output timing is delayed so that the output position in the conveyance direction is offset by 1 mm.

On the other hand, in FIG. 5, (f) illustrates the image data with its magnification corrected by the image correction unit 207. The magnification factor is determined to suppress the amount of the positional deviation amount δ caused by shrinking of the image G1 in accordance with the printing ratio. Then, magnification correction is performed by multiplying the image data by the determined magnification factor to enlarge the entire image data to correct the image data. Prior to printing, the image data is enlarged after multiplying by the determined magnification factor. In the example of (f) of FIG. 5, the image data after the magnification correction is larger than the size of the sheet.

In FIG. 5, (g) illustrates the printed product with the image magnification corrected, where the trailing edge of the image G1 is positioned at the center of the sheet. Since the amount of the positional deviation δ of the trailing edge of the image G1 in the conveyance direction of the A3 sheet is 1 mm, when applying a constant magnification to the entire A3 image for magnification correction, the amount of the positional deviation of the trailing edge of the image data is twice the 1 mm in the conveyance direction, i.e., 2 mm. Further, since the length of the A3 sheet in the conveyance direction is 420 mm, the magnification factor multiplied across the entire image data is set to 422 mm/420 mm=1.004. This enables positioning the trailing edge of the image G1 at the center of the sheet in the printed product.

### Printing Flow

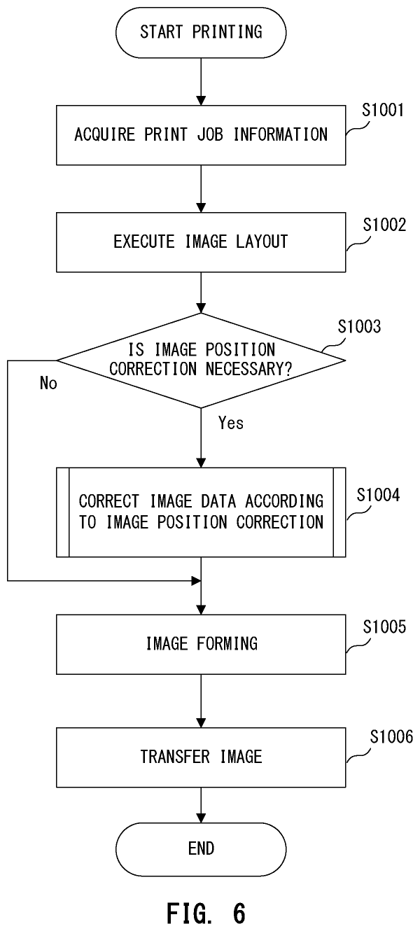

FIG. 6 is a flowchart illustrating the printing process. In a case where an operator submits a print job containing print commands, the CPU 114 acquires the print job information from the host computer 101 (Step S1001). The CPU 114 performs image layout on a single sheet for multiple images according to the job information by the image layout unit 208 (Step S1002). The CPU 114 determines whether or not the image position correction based on the print job information acquired in step S1001 (Step S1003). In the first embodiment, the image position correction is determined to be necessary in a case where the print job involves folding the sheet at its center position. Examples of jobs involving folding the sheet at its center position include print jobs for saddle stitching and print jobs for creating folded pamphlets.

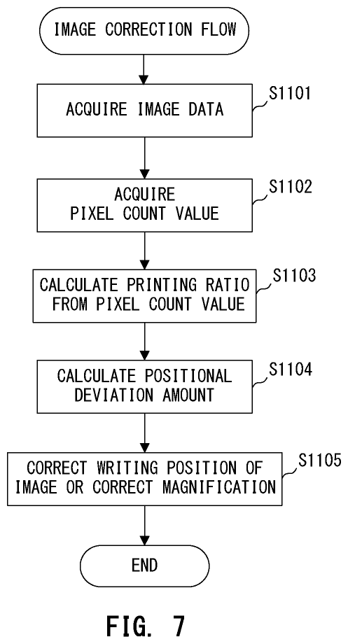

In a case where the image position correction is not required (Step S1003: No), the CPU 114 performs image forming using the image forming unit 200 without correcting the image data (Step S1005), transfers the image (Step S1006), and completes printing. In a case where the image position correction is required (Step S1003: Yes), the CPU 114 corrects the image data by using the image correction unit 207 (Step S1004) so that the image position on the printed product is centered on the sheet. The detailed flow for correcting the image data is described later with reference to FIG. 7. The CPU 114 performs the image formation using the image data corrected in Step S1004 using the image forming unit 200 (Step S1005) to transfer the formed image onto the sheet (Step S1006) and completes printing.

In the example of FIG. 6, the condition for correcting the image data is whether the print job involves folding the sheet at the center position. However, folding may be performed by a device separate from the image forming apparatus 100. Therefore, as an alternative embodiment, instead of determining whether or not the print job involves folding the sheet at the center position, it may be determined whether the job involves assigning multiple images to a single sheet.

### Image Data Correction Flow

FIG. 7 is a flowchart illustrating the process for aligning the image output position with the sheet center position. In this example, a process for aligning the image center position with the sheet center position (folding position) is illustrated. The image data for a print job folding the sheet at the center position includes an image laid out to the downstream side in the conveyance direction and an image laid out to the upstream side in the conveyance direction. Similar to FIG. 5, these images are referred to as “image G1” and “image G2”, respectively.

The CPU 114 acquires the image data to be printed (Step S1101) and acquires the pixel count value for the image G1 contained in the image data acquired in step S1101 from the pixel count unit 205 (Step S1102). The CPU 114 calculates the printing ratio of the image G1 from the pixel count value acquired in step S1102 (Step S1103). The CPU 114 calculates the positional deviation amount δ of the trailing edge of the image G2, caused by the change in a sheet conveyance speed corresponding to the printing ratio, using Equation 1 based on the printing ratio acquired in step S1103 (Step S1104)

The CPU 114 controls the image correction unit 207 to correct the image data (Step S1105) based on the amount of the positional deviation calculated in step S1104 so that the trailing edge position of the image G1 in the conveyance direction aligns with the sheet center position on the printed product. This correction is selectively performed using either the correction of the image output position illustrated in (d) and (e) of FIG. 5 (first correction), or the magnification correction of the image data illustrated in (f) and (g) of FIG. 5 (second correction). The selection between the first correction and the second correction can be made using any method. For example, the CPU 114 compares the effect of the positional deviation at the image position of the leading edge of the image G1 with the effect of the positional deviation at the image position of the trailing edge of the image G2 for the image data. Then, the CPU 114 determines whether to select the first correction or the second correction based on the comparison result.

For example, in a case where the effect of the positional deviation at the leading edge image position of the image G1 is greater than the effect of the positional deviation at the trailing edge image position of the image G2, it is determined to perform the first correction. In this example, the CPU 114 determines to perform the first correction in a case where the amount of image shrinkage in the image G1 is greater than the amount of shrinkage in the image G2. Furthermore, in a case where the effect of the positional deviation at the leading edge image position of the image G1 is equal to or smaller than the effect of the positional deviation at the trailing edge image position of the image G2, it is determined to perform the second correction.

Alternatively, the selection between the first correction and the second correction may be determined manually. In this case, for example, a selection screen for selecting one of the first correction and the second correction is displayed on the operation panel 120, allowing the operator to input which correction to perform. By performing the above processing, it becomes possible to correct the output position or the magnification of the image data to be printed based on the amount of the positional deviation at the trailing edge of the image G1, thereby aligning the front edge of the image G2 at the center of the sheet. In the above description, for each of the images G1 and G2, the printing ratio to correct the image data is calculated, however, it is not necessarily required to calculate the printing ratio for all multiple images. For example, in a case where aligning the trailing edge of the image G1 (the front edge of the image G2) to the sheet center position is important, while the position of the trailing edge of the image G2 is less important, it is not necessary to calculate the printing ratio for the image G2.

### Second Embodiment

In the first embodiment, a method has been described for aligning the center of the image with the center of the sheet by correcting the image writing position in the sub-scanning direction and correcting the image magnification in the sub-scanning direction.

However, in the first embodiment, when performing the correction of the image writing position as a correction for the image data, a margin amount at the leading edge side of the sheet in the sub-scanning direction may increase or decrease. On the other hand, when performing the magnification correction, the margin amount at the trailing edge side of the sheet may increase or decrease, thus, potentially resulting in an improper margin amount. Therefore, the second embodiment describes a method for aligning the image center position with the sheet center position while appropriately maintaining the margin amount, using a partial magnification correction that performs magnification correction for each divided region in the sub-scanning direction.

### Method for Aligning Image Center Using Partial Magnification Correction

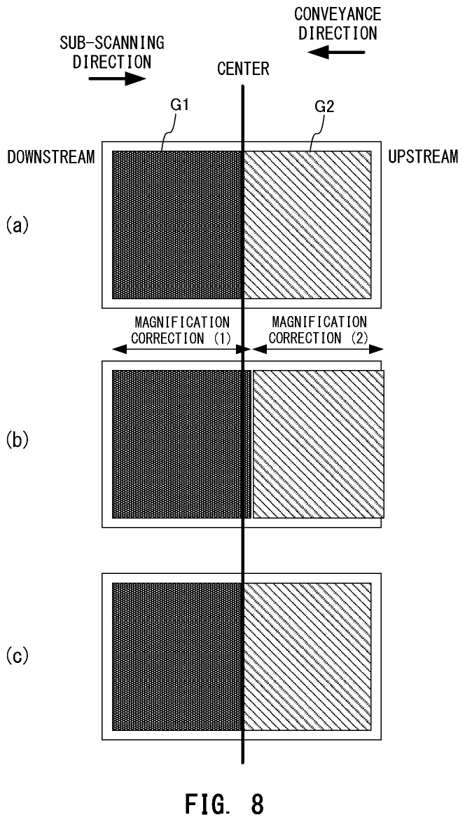

FIG. 8 illustrates explanatory diagrams of image data correction using the partial magnification correction. In the printed product where the sheet is folded in half, such as saddle stitched books or folded pamphlets, the printing ratio of the image on the leading edge side portion of the sheet in the sub-scanning direction may differ from printing ratio on the trailing edge side portion of the sheet. Similar to FIG. 5, the center position of the sheet (indicated as “Center” in the figure) corresponds to the fold position of in the saddle stitching. With reference to these figures, a method for aligning the image center position with the sheet center position while maintaining appropriate margins. Unless otherwise specified, the configuration excluding the image data magnification correction in the second embodiment is common with the first embodiment.

In FIG. 8, (a) illustrates an example of dividing image data before printing into multiple regions in the sub-scanning direction. In this example, an image of printed product, which is to be folded at the center of the sheet in the post processing such as saddle stitching, into two regions using the image center (folding position) as a boundary. Similar to FIG. 5, the image in the downstream half region of the sheet in the conveyance direction is illustrated as the image G1, and the image in the downstream half region in the conveyance direction is illustrated as the image G2. For simplicity, the symbols G1 and G2 representing images G1 and G2, respectively, are illustrated only in (a) of FIG. 8.

In the example of (a) of FIG. 8, image data in which the image G1 has a high printing ratio and the image G2 has a low printing ratio is printed onto sheet A3. Among the two divided images, the image G1 is reduced by 1.5 mm, thus the positional deviation occurs in the image. On the other hand, since the image G2 has the low printing ratio, it is considered that no significant reduction occurs in the image G2.

In FIG. 8, (b) illustrates the state after applying magnification correction to each of the two divided image regions, i.e., the image G1 and the image G2. As illustrated, the image G1 is enlarged to compensate for the reduction of 1.5 mm, while the image G2 is neither enlarged nor reduced. Therefore, the CPU 114 applies a magnification correction (1) of 211.5 mm/210 mm=1.007 to the image G1. For the image G2, a magnification correction (2) is performed, however, since no positional deviation of the image occurs in this example, no magnification correction is applied (or the magnification value is set to 1). As a result, in the image data, the trailing edge of the image G2 extends beyond the trailing edge of the sheet.

In FIG. 8, (c) illustrates the printed product after applying the magnification correction to the image data. As illustrated, in the printed product, the trailing edge of the image G1 and the front edge of the image G2 are positioned at the center of the sheet. Further, the margin between the front edge of the image G1 and the front edge of the sheet as well as the margin between the trailing edge of the image G2 and the trailing edge of the sheet are both appropriately maintained. Thus, by performing the magnification correction to suppress the positional deviation occurring in both of the image G1 and the image G2, it is possible to appropriately maintain the margins described above.

### Process Flow for Generating Printed Image Data Using Partial Magnification Correction

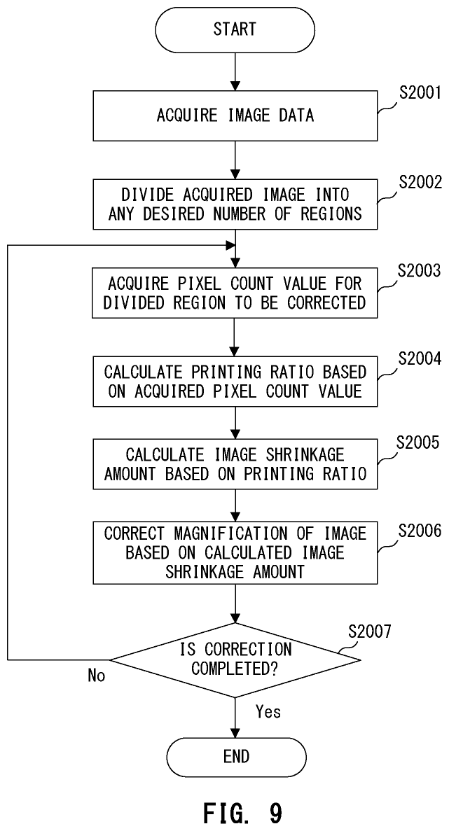

FIG. 9 is a flowchart illustrating the correction of the image data using the partial magnification correction. This flowchart explains, as to the image data correction process performed in step S1003 of the printing flow described in FIG. 6, the process of aligning the center of the image with the center of the sheet using the partial magnification correction described above. The CPU 114 acquires the image data to be printed (Step S2001) and divides the acquired image into any desired number of regions (Step S2002). Examples of boundaries for division include the boundaries of the input image data laid out in step S1002 or the fold positions when performing folding operations such as saddle stitching

The CPU 114 acquires the pixel count value of the image data for the divided region to be printed from the pixel count unit 205 (Step S2003) and calculates the printing ratio based on the acquired pixel count value (Step S2004). The CPU 114 calculates the image shrinkage amount based on the printing ratio (Step S2005) calculated in step S2003 and corrects the magnification of the image based on the calculated image shrinkage amount (Step S2006). The CPU 114 determines whether correction processing for all divided regions has been completed (Step S2007). If there are divided regions where the correction has not been performed (Step S2007: No), processing from step S2003 onward is performed. In a case where the correction processing for all divided regions has been completed (Step S2007: Yes), the CPU 114 terminates processing.

By performing the above processing, the magnification correction for each divided region is performed on the image data to be printed, based on the pixel count values of the image regions divided in the sub-scanning direction. Thus, it is possible to position the trailing edge of the image G1 or the leading edge of the image G2 at the center position of the sheet. Further, it becomes possible to appropriately maintain the margin amount between the leading edge of the image G1 and the leading edge of the sheet, and the margin amount between the trailing edge of the image G2 and the trailing edge of the sheet.

The number of divisions of the image data is not limited to two, and the image data may be divided into any number of regions as long as the fold position of the image is included as a boundary between the divided regions. For example, in a case where the image data is divided into three regions, the regions are designated as G1 through G3. The printing ratio is calculated for each region, enabling determination of the image shrinkage amount and the positional deviation from the image leading edge in the printed image.

In a case where the image data is divided into n regions, each region is denoted as G1 through Gn. In a case where the image data is divided into n regions, an amount of the partial magnification correction is determined for each region based on the calculated image shrinkage amount. Magnification correction is then performed on each region of the image data using the determined amount of the partial magnification correction. The first and second embodiments described above also enable the provision of an image forming apparatus capable of suppressing the positional deviation of the center position etc., of a sheet in printed product where multiple images are assigned to a single sheet, such as saddle stitching or folded pamphlets.

According to the present disclosure, an image forming technology that suppresses positional deviation of an image is provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-050627, filed Mar. 25, 2025, which is hereby incorporated by reference herein in its entirety.

What is claimed is:

1. An image forming apparatus, comprising:
an image forming unit configured to form an image on an image bearing member using toner;
a transfer member configured to transfer the image on the image bearing member onto a sheet while conveying the sheet in a conveyance direction; and
a controller configured to:
perform a print job to form a first page image on a downstream side of a center position of the sheet in the conveyance direction and form a second page image on an upstream side of the center position of the sheet in the conveyance direction; and
control, in the print job, image formation by the image forming unit based on a toner amount of the first page image such that a downstream edge of the second page image in the conveyance direction is positioned at the center position of the sheet.

2. The image forming apparatus according to claim 1, wherein the controller is configured to control the position of a leading edge of the first page image based on the toner amount of the first page image.

3. The image forming apparatus according to claim 1, wherein the controller is configured to control a magnification of the image in the conveyance direction based on the toner amount of the first page.

4. The image forming apparatus according to claim 1,
wherein the image forming unit is configured to form an image based on image data, and
wherein the controller includes a determination unit configured to determine the toner amount based on the image data.

5. The image forming apparatus according to claim 1, wherein the toner amount is acquired using a printing ratio of the first page image.

6. The image forming apparatus according to claim 1, wherein the toner amount is acquired using density values of pixels included in the first page image.

7. The image forming apparatus according to claim 1, wherein the controller is configured to control the image formation by the image forming unit such that the downstream edge of the second page image in the conveyance direction is positioned at the center position of the sheet by correcting a writing position of the image with respect to the sheet.

8. The image forming apparatus according to claim 1, wherein the controller is configured to control a magnification of the first page image in the conveyance direction such that the downstream edge of the second page image is positioned at the center position of the sheet.

9. The image forming apparatus according to claim 1,
wherein the controller is configured to selectively perform a first correction and a second correction in the image formation by the image forming unit,
wherein the controller is configured, in the first correction, to control the image formation by the image forming unit by correcting the writing position of the image with respect to the sheet such that the downstream edge of the second page image in the conveyance direction is positioned at the center position of the sheet, and
wherein the controller is configured, in the second correction, to control a magnification of the first page image in the conveyance direction such that the downstream edge of the second page image in the conveyance direction is positioned at the center position of the sheet.

10. The image forming apparatus according to claim 9, further comprising an operation unit configured to display, to an operator, a selection screen for selecting one of the first correction and the second correction.

11. An image forming apparatus, comprising:
an image forming unit configured to form an image on an image bearing member using toner;
a transfer member configured to transfer the image on the image bearing member onto a sheet while conveying the sheet in a conveyance direction; and
a controller configured to:
perform a print job to form a first page image on a downstream side of a center position of the sheet in the conveyance direction and form a second page image on an upstream side of the center position of the sheet in the conveyance direction; and
control, in the print job, image formation by the image forming unit based on a toner amount of the first page image such that an upstream edge of the first page image in the conveyance direction is positioned at the center position of the sheet.

12. The image forming apparatus according to claim 11, wherein the controller is configured to control a leading edge of the first page image based on the toner amount of the first page image.

13. The image forming apparatus according to claim 11,
wherein the controller is configured to control a magnification of the image in the conveyance direction based on the toner amount of the first page.

14. The image forming apparatus according to claim 11,
wherein the image forming unit is configured to form an image based on image data, and
wherein the controller includes a determination unit configured to determine the toner amount based on the image data.

15. The image forming apparatus according to claim 11,
wherein the toner amount is acquired using a printing ratio of the first page image.

16. The image forming apparatus according to claim 11,
wherein the toner amount is acquired using density values of pixels included in the first page image.

17. The image forming apparatus according to claim 11,
wherein the controller is configured to control the image formation by the image forming unit such that the upstream edge of the first page image in the conveyance direction is positioned at the center position of the sheet by correcting a writing position of the image with respect to the sheet.

18. The image forming apparatus according to claim 11,
wherein the controller is configured to control a magnification of the first page image in the conveyance direction such that the upstream edge of the first page image is positioned at the center position of the sheet.

19. The image forming apparatus according to claim 11,
wherein the controller is configured to selectively perform a first correction and a second correction in the image formation by the image forming unit,
wherein the controller is configured to control, in the first correction, the image formation by the image forming unit by correcting the writing position of the image with respect to the sheet such that the upstream edge of the first page image in the conveyance direction is positioned at the center position of the sheet, and
wherein the controller is configured to control, in the second correction, a magnification of the first page image in the conveyance direction such that the upstream edge of the first page image in the conveyance direction is positioned at the center position of the sheet.

20. The image forming apparatus according to claim 19,
further comprising an operation unit configured to display, to an operator, a selection screen for selecting one of the first correction and the second correction.
